(19) United States
(12) Patent Application Publication
(10) Pub. No.: US 2020/0334777 A1
(43) Pub. Date: Oct. 22, 2020

(54) INTELLIGENT EMERGENCY DECISION SUPPORT SYSTEM FOR EMERGENCY COMMUNICATION

(71) Applicant: Beijing Yutian Technology Co. Ltd, Beijing (CN)

(72) Inventor: Libao YAN, Beijing (CN)

(21) Appl. No.: 16/687,652

(22) Filed: Nov. 18, 2019

(30) Foreign Application Priority Data
Apr. 17, 2019 (CN) 201910306985.3

(51) Int. Cl. G06Q 50/26; H04W 4/90; G06F 16/25; G06F 16/23; G06Q 10/06; G06N 5/04

(52) U.S. Cl. CPC G06Q 50/265; H04W 4/90; G06N 5/04; G06F 16/2379; G06Q 10/0637; G06F 16/258

(57) ABSTRACT

The present invention discloses an intelligent emergency decision support system for emergency communication, and the system is established based on various models and automatically integrates information from various sources and information in various data formats. Intelligent automatic classification, clustering, automatic correlation and personalized processing are conducted through deep digging, collision and analysis of various data resources on each system platform. Based on big data platform and assistant decision-making model, the system can automatically implement one-stop automatic analysis, automatically generate disposal schemes and communication support schemes for the disposal of emergencies, and evaluate communication support schemes according to different site environments and requirements, give suggestions for evaluation reports and regenerate specific evaluation reports. Intelligent and standardized emergency disposal is really realized, so as to improve the decision-making command and rapid response ability, so that emergencies can be dealt with in the shortest time to minimize disaster losses.

### TECHNICAL FIELD

The present invention relates to the command and management field of emergency communication, in particular to an intelligent emergency decision support system for emergency communication.

### BACKGROUND ART

In recent years, China has severe public security situation, natural disasters and accidents occur frequently, public health events and social security events happen constantly, and there are still threats to national security. The Chinese government attaches great importance to disposal of emergency events, and especially after the 2008 Wenchuan Earthquake, the State Council has put forward higher requirements for emergency disposal. In order to improve the emergency communication disposal ability for emergency events, the current situation of the communication industry is combed in the paper, and from the perspective of emergency complying with the current industry, an intelligent emergency decision support system is established for exploration around the construction of informationized emergency command platform in the communication industry, so as to improve the command and dispatch ability of emergency communication of our country in an all-round way.

At present, most of the existing emergency command systems in the communication industry do not fully have the functions of automatic analysis, active presentation and assistant decision-making support in the process of emergency disposal. Information reporting, receiving and processing, surrounding environment analysis, emergency resource rescue route planning, emergency communication support scheme, disposal scheme and summary evaluation report are all completed manually. However, this method not only causes waste of human and material resources, but also seriously reduces the efficiency of emergency rescue and disposal capability of emergency communication.

### Contents of the Invention

In view of all kinds of assistant decision-making analysis requiring to be completed manually at present during emergency command and dispatch in the communication industry, including the analysis for the surrounding situation of emergencies, emergency resource dispatch, emergency communication support scheme, disposal scheme and summary evaluation, seriously reducing the emergency disposal ability and emergency rescue efficiency, the present invention discloses an intelligent comprehensive analysis of realizing emergency command and dispatch based on GIS, big data, artificial intelligence and other technologies, so as to improve the ability of decision-making command and rapid response, make emergencies disposed quickly in the shortest time, and reduce disaster losses to the minimum.

The present invention is realized by the following technical scheme: an intelligent emergency decision support system for emergency communication includes the following contents:

Data Collection: Baseline telecom operators regularly or timely on demand input relevant network management data of public communication network into the information collection interface system. Then, the information after extraction and conversion is input into the big data platform for emergency by the system to analyze and make statistics of storage and data quality, so as to supply users for analysis and decision-making

Data Integration: Data information such as emergency resources, network management information, historical emergency plans and emergency knowledge are extracted from emergency platform database and network management system for integration, and real-time or quasi-real-time updating of data is ensured.

Model Management: Based on various combinations of environmental conditions, digital terrain, network parameters, and emergency degree and classification of emergency events, some popular international algorithms are revised and stored in model database to form a basic database for assistant decision-making. The model database shall have an open interface for users, allowing users to further modify the model according to the actual situation to adapt to a specific environment.

Knowledge Management: The rules, specifications, deployment techniques and methods of various communication networks related to emergency guarantee are stored in the knowledge database separately as the basis of reasoning when generating and evaluating the scheme.

Scheme Management: The scheme generation and maintenance combines use requirements and specific site environment, reasoning technology is used to form several schemes, and the scheme evaluation module is provided for use. The above results are taken as parameters and constraints of scheme generation, and several emergency plans are reasoned and generated under the support of model database, knowledge database and related database. Meanwhile, the emergency plan generated is revised and adjusted according to the scene situation and instructions of superiors and leaders.

Plan Correlation: According to the digitized emergency plan in advance, the corresponding plan start conditions are configured, and the data types reported by enterprises are correlated with corresponding plans. When the trigger conditions of the corresponding plan are reached or exceeded, the start suggestions of the corresponding plan response are triggered in time, and then transferred to the emergency plan response process after the confirmation of commanding and decision-making personnel.

The system provides the management of triggering conditions of plans, including the designation of event type, the area where an event is located, event level, and keywords. The start conditions of the plan are set for the data collected by data collection, and the system automatically prompts users whether to start relevant plans when the preset conditions are met.

Intelligent Comprehensive Analysis: Based on collected data, including network management information, emergency reporting, and on-site audio and video information, the system has analysis processes of displaying the scene globally through GIS, analyzing the surrounding topography and hazards, matching the nearest emergency resources according to the geographical position where the scene is located, and initiating emergency plans, automatically assigning emergency tasks and forming a disposal plan and an emergency guarantee plan.

Furthermore, the data collection mentioned also includes comparison and analysis through data acquired (such as daily zero report, and monitoring and alarm of base stations), and setting of alarm threshold (when the collected data reaches the threshold, the system automatically starts emergency plan response).

Furthermore, the model management mentioned also includes the establishment of a forecasting and early warning model database for emergency communication through a decision tree, logical regression, linear regression and other algorithms, and the establishment of an emergency resource scheduling analysis model through various emergency plans and emergency resource databases.

Furthermore, the scheme management mentioned includes, combining emergency task requirements, evaluation of several plans generated by the scheme generation and modification module to obtain evaluation opinions and optimization suggestions on the scheme for reference of adjustment and modification of the scheme by relevant personnel.

Furthermore, the intelligent comprehensive analysis mentioned also includes the scheduling analysis of emergency resources such as communication support teams, social support resources and emergency material reserves.

Furthermore, the intelligent comprehensive analysis mentioned also includes one-button starting remote consultation and collaborative plotting, namely, in the process of emergency disposal, a remote online consultation function based on an emergency map is provided through the GIS system, so personnel of all units engaged in the event disposal can participate in the consultation remotely, conduct collaborative plotting, and jointly analyze the development of the event situation.

Compared with the existing technology, the present invention has the following advantages and beneficial effects:

According to the specific environment of the emergency communication command site, the present invention automatically generates various emergency communication support schemes and emergency disposal schemes by the reported data analysis in combination with various established models, and evaluates communication support schemes according to different field environments and requirements, gives reference suggestions, and regenerates specific communication support implementation plans. Intelligent and standardized emergency disposal is really realized, and emergency resources and resource scheduling are automatically analyzed, so that leaders can grasp the overall situation, assist in decision-making analysis and improve emergency decision-making efficiency.

### ILLUSTRATIONS

In order to make contents of the present invention understood more easily and clearly, the present invention is further described in detail in accordance with specific embodiments of the present invention and figures, where

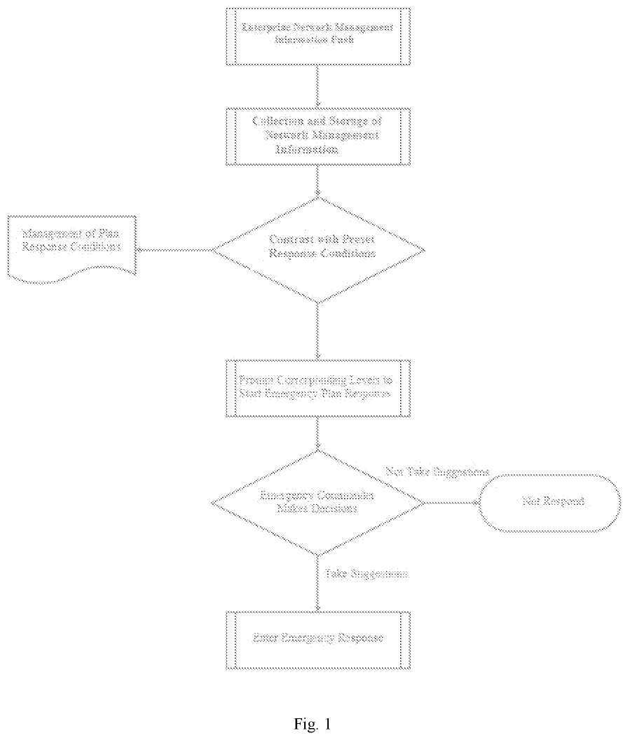

FIG. 1 shows the architecture of an intelligent emergency decision support system for emergency communication in an embodiment of the present invention;

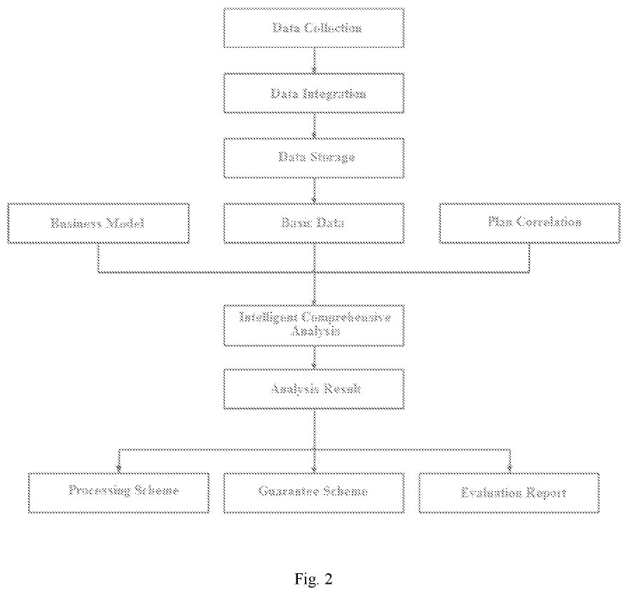

FIG. 2 shows a flowchart of an intelligent emergency decision support system for emergency communication in an embodiment of the present invention;

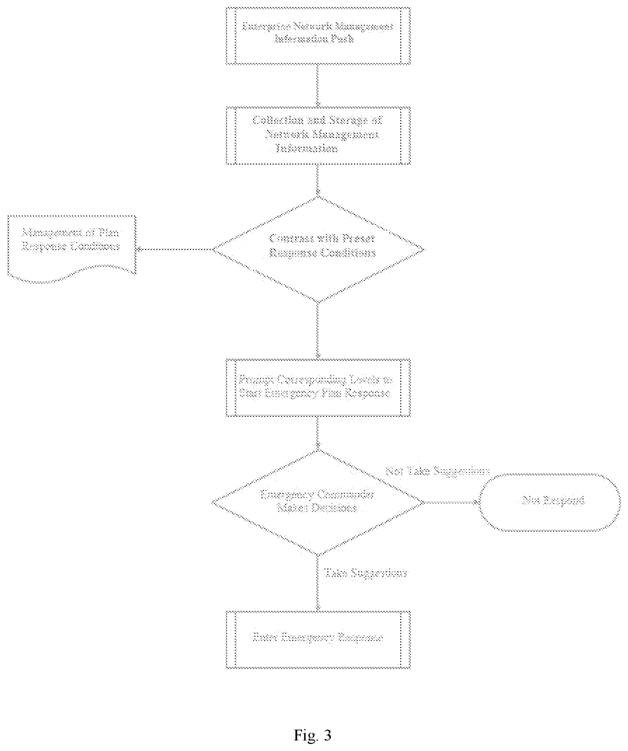

FIG. 3 shows an emergency plan triggering flowchart for communication support in an embodiment of the present invention.

### EMBODIMENTS

The following contents are detailed descriptions for embodiments of the present invention combined with figures. The following embodiments are used to describe the present invention but are not used to limit the scope of the present invention.

As shown in FIG. 1, the present invention provides the architecture diagram of an intelligent emergency decision support system for emergency communication, and the architecture of the system is divided into data collection layer, data storage layer, application support layer and business function layer from bottom to top. The above layers separately provide the corresponding data access and storage services, general supporting component services, basic support platform services to support development and operation, and specific business applications realized by underlying components and services, and show specific business applications to end users.

Business Function Layer: (1) Intelligent analysis: on the basis of various models, intelligent automatic classification, clustering, automatic correlation and personalized processing are conducted through deep research, collision and analysis of various data resources on each system platform to help leaders discover hotspots of massive information and trends of information development in the system, and provide strong support for leaders to make emergency decision. The system can provide all kinds of data needed for emergency disposal, and alternative reference schemes according to specific environments of emergency disposal site and specific situations of leaders, and evaluate the alternative reference schemes according to different site environments and requirements. The system automatically generates various emergency communication support schemes and emergency disposal schemes based on the big data platform and various algorithm models according to specific environments of emergency command site and specific situations of leaders, evaluates communication support schemes according to different site environments and requirements, gives reference suggestions and regenerates specific communication support implementation plans. Intelligent and standardized emergency disposal is really realized, and emergency resources and resource scheduling are automatically analyzed, so that leaders can grasp the overall situation and assist in decision-making analysis. (2) Collaborative Plotting: joint analysis of the development of the event situation. The situation plotting system provides abundant visual operational information, which makes commanders grasp the situation at the scene more accurately and make decisions more quickly. Meanwhile, the system greatly improves the real-time, interactivity and dynamicity of situation analysis process, and provides strong support for command and decision-making.

Application Support Layer: (1) GIS Platform: the remote consultation and collaborative plotting are initiated based on GIS platform. In the process of emergency disposal, the remote online consultation function based on an emergency map is provided through GIS system, so the personnel of all units involved in event disposal can participate in the consultation remotely. (2) Business Model: all kinds of analysis models and data resources integration are established. Classification, clustering, correlation and other algorithms in machine learning are used for deep digging. The models established include prediction and early warning model, event study and determination model, emergency resource scheduling model, emergency resource analysis model, summary evaluation model, etc.

Data Storage Layer: Data resource layer provides mechanism of data storage, management and resource access, and provides data and resource services for the above layers. The layer mainly establishes basic information database, GIS information database, emergency resource database, resource sharing database of various units, emergency material database, etc. The structured data is mainly stored in oracle relational database, and unstructured and semi-structured data are stored in Hadoop big data platform, which supports the dynamic expansion of server storage capacity and provides big data analysis for command decision-making and emergency decision-making support. The big data platform adopts Hadoop+Hbase+Spark architecture, supports structured, unstructured and semi-structured data, backs dynamic expansion of file storage, and provides distributed storage of massive data and high-performance distributed computing framework. Data analysis such as data digging analysis and decision-making support is completed.

Data Collection Layer: Access to baseline telecom operators and emergency platforms, baseline telecom operators regularly or timely on demand input relevant network management data of public communication network into the information collection interface system. Then, the information after extraction and conversion is input into the big data platform for emergency by the system to analyze and make statistics of storage and data quality, so as to supply users for analysis and decision-making Data information of emergency plans and plan evaluation is extracted and generated from emergency platform database and related systems, and real-time or quasi-real-time updating of data is ensured.

As shown in FIG. 2, the present invention provides a flowchart of an intelligent emergency decision support system for emergency communication. After an emergency occurs, the user leader can see the reported event information and videos through the system to understand the scene of the event in detail, and decide how to dispose and dispatch according to the scene situation. Specifically the following steps are included:

Step 1: Baseline telecom operators regularly or timely on demand input the relevant data of the public communication network into the information collection interface system. Then, the information collection system inputs the information after extraction and conversion into the business database.

Step 2: Data information such as emergency resources, network management information, historical emergency plans and emergency knowledge are extracted from emergency platform database and network management system for integration, and real-time or quasi-real-time updating of data is ensured.

Step 3: Data resource layer provides mechanism of data storage, management and resource access, and provides data and resource services for the above layers. The layer mainly establishes basic information database, GIS information database, emergency resource database, resource sharing database of various units, emergency material database, etc. The structured data is mainly stored in oracle relational database, and unstructured and semi-structured data are stored in Hadoop big data platform, which supports the dynamic expansion of server storage capacity and provides big data analysis for command decision-making and emergency decision-making support.

Step 4: Intelligent comprehensive analysis is conducted based on the collected basic data, established various business models, plan correlation and other information. The system can automatically and quickly analyze the emergency resources such as the nearest communication support teams, social support resources and emergency material reserves. One-button starting remote consultation and collaborative plotting: In the process of emergency disposal, the remote online consultation function based on an emergency map is provided by GIS system, so personnel of all units involved in event disposal can participate in the consultation remotely, conduct collaborative plotting, and analyze the development of the event situation together. The situation plotting system provides abundant visual operational information, which makes commanders grasp the situation at the scene more accurately and make decisions more quickly. Meanwhile, the system greatly improves the real-time, interactivity and dynamicity of situation analysis process, and provides strong support for command and decision-making

Step 5: The system automatically generates the analysis results of the accident, including emergency disposal plans and communication support plans after the analysis of the above steps. Finally, according to the set evaluation index and model, the system conducts qualitative and quantitative evaluation on the speed of the accident disposal, the degree of task completion and the ability of emergency disposal, and automatically generates an evaluation report.

FIG. 3 shows an emergency plan triggering flowchart for communication support provided by the present invention. The flowchart specifically includes the following steps:

Step 1: The network management information of baseline operators is pushed to a collection front-end processor.

Step 2: The system analyzes, processes and stores collected network management information.

Step 3: Relevant plans can be maintained in advance in the plan system, which includes trigger conditions of the plan. The trigger conditions include the event type, the area where events are located and the level of events aimed at by the plan, and keywords. The system automatically compares the collected network management information with the preset response conditions.

Step 4: When the preset conditions are met, the system automatically prompts users whether to start relevant plans so that the emergency commander makes decisions. If the system suggestions are adopted, the system will enter the emergency response process. If not, the system suggestions will be ignored and the system will not enter the emergency response.

1. An intelligent emergency decision support system for emergency communication, characterized by the following:
Data Collection: Baseline telecom operators regularly or timely on demand input relevant network management data of public communication network into the information collection interface system, Then, the information after extraction and conversion is input into the big data platform for emergency by the system to analyze and make statistics of storage and data quality, so as to supply users for analysis and decision-making;
Data Integration: Data information such as emergency resources, network management information, historical emergency plans and emergency knowledge are extracted from emergency platform database and network management system for integration, and real-time or quasi-real-time updating of data is ensured;
Model Management: Based on various combinations of environmental conditions, digital terrain, network parameters, and emergency degree and classification of emergency events, some popular international algorithms are revised and stored in model database to form a basic database for assistant decision-making, The model database shall have an open interface for users, allowing users to further modify the model according to the actual situation to adapt to a specific environment;
Knowledge Management: The rules, specifications, deployment techniques and methods of various communication networks related to emergency guarantee are stored in the knowledge database separately as the basis of reasoning when generating and evaluating the scheme;
Scheme Management: The scheme generation and maintenance combines use requirements and specific site environment, reasoning technology is used to form several schemes, and the scheme evaluation module is provided for use, The above results are taken as parameters and constraints of scheme generation, and several emergency plans are reasoned and generated under the support of model database, knowledge database and related database, Meanwhile, the emergency plan generated is revised and adjusted according to the scene situation and instructions of superiors and leaders;
Plan Correlation: According to the digitized emergency plan in advance, the corresponding plan start conditions are configured, and the data types reported by enterprises are correlated with corresponding plans, When the trigger conditions of the corresponding plan are reached or exceeded, the start suggestions of the corresponding plan response are triggered in time, and then transferred to the emergency plan response process after the confirmation of commanding and decision-making personnel, The system provides the management of triggering conditions of plans, including the designation of event type, the area where an event is located, event level, and keywords, The start conditions of the plan are set for the data collected by data collection, and the system automatically prompts users whether to start relevant plans when the preset conditions are met;
Intelligent Comprehensive Analysis: Based on collected data, including network management information, emergency reporting, and on-site audio and video information, the system has analysis processes of displaying the scene globally through GIS, analyzing the surrounding topography and hazards, matching the nearest emergency resources according to the geographical position where the scene is located, and starting emergency plans, automatically assigning emergency tasks and forming a disposal plan and an emergency guarantee plan.

2. The intelligent emergency decision support system for emergency communication described in claim 1, is characterized in that the data collection mentioned also includes comparison and analysis through data acquired (such as daily zero report, and monitoring and alarm of base stations), and setting of alarm threshold (when the collected data reaches the threshold, the system automatically starts emergency plan response).

3. The intelligent emergency decision support system for emergency communication described in claim 1, is characterized in that the model management mentioned also includes the establishment of a prediction and early warning model database for emergency communication through a decision tree, logical regression, linear regression and other algorithms, and the establishment of an emergency resource scheduling analysis model through various emergency plans and emergency resource databases.

4. The intelligent emergency decision support system for emergency communication described in claim 1, is characterized in that the scheme management mentioned includes, combining emergency task requirements, evaluation of several plans generated by the scheme generation and modification module to obtain evaluation opinions and optimization suggestions on the scheme for reference of adjustment and modification of the scheme by relevant personnel.

5. The intelligent emergency decision support system for emergency communication described in claim 1, is characterized in that the intelligent comprehensive analysis mentioned also includes the scheduling analysis of emergency resources such as communication support teams, social support resources and emergency material reserves.

6. The intelligent emergency decision support system for emergency communication described in claim 1, is characterized in that the intelligent comprehensive analysis mentioned also includes one-button starting remote consultation and collaborative plotting, namely, in the process of emergency disposal, a remote online consultation function based on an emergency map is provided through the GIS system, so personnel in all units engaged in the event disposal can participate in the consultation remotely, conduct collaborative plotting, and jointly analyze the development of the event situation.
